(19) United States
(12) Patent Application Publication
(10) Pub. No.: US 2010/0204886 A1
(43) Pub. Date: Aug. 12, 2010

(54) METHOD AND SYSTEM FOR INCREASING A VEHICLE SIDE SLOPE OPERATING CAPABILITIES

(75) Inventor: Patrick J. Fitzgibbons, Owego, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 12/370,210

(22) Filed: Feb. 12, 2009

(51) Int. Cl. B60G 17/0165

(52) U.S. Cl. 701/38

(57) ABSTRACT

A method and system for orienting the attitude of a vehicle. The method includes determining a path of travel of the vehicle, determining a slope of the terrain over the path of travel, and adjusting a height of at least one adjustable support of the vehicle.

### STATEMENT REGARDING FEDERALLY SPONSORED RESEARCH OF DEVELOPMENT

This invention was made and funded by the U.S. Government, specifically by the U.S. Army Tank-Automotive & Armaments Co. under Contract W56HZV-05-9-0002. The U.S. Government has certain rights in the invention.

### FIELD OF THE INVENTION

A method and system for orienting the attitude of a vehicle, more particularly, a method and system of increasing or enhancing the side slope operating capabilities of a vehicle.

### BACKGROUND OF THE INVENTION

Often, operation of an off-road vehicle requires that the vehicle proceed over non-level ground. In connection with such operation, the path of the vehicle may not remain level but, instead, may follow a hillside. Where the path is not horizontal, the attitude of the vehicle acquires the attitude or slope of the path and the vehicle may become prone to instability, that is, to rolling over or sliding downhill.

### BRIEF SUMMARY OF THE INVENTION

Stability of the vehicle when traversing a non-level or non-horizontal path is enhanced by the vehicle being oriented such that the plane of its chassis is more level or more horizontal than if the plane of the chassis were parallel to the plane of the path along the hillside. The side slope capability of the vehicle is then increased beyond the side slope capability based on the track width and the center of gravity of the vehicle alone.

The method and system of the present invention increases a vehicle's side slope traversing capabilities. With fully controllable ride height of individual wheel stations, such as can be provided on certain tactical vehicles, it is possible to drive the down hill side of the vehicle to its maximum ride height, and the up hill side to its minimum ride height, thus tending to level the vehicle and increase its side slope operational capability.

This invention is particularly useful for, but not limited to, Future Tactical Truck Systems (FTTS). Many off-road vehicles require that they can operate on very steep side slopes, and the present invention provides a method and system for increasing the side slope capability as mentioned above.

The present invention provides a fully adjustable independent suspension, such as pneumatic, hydraulic, and the like, with significant ride height adjustment capabilities, so that it is possible to lower the uphill side of a vehicle to its lowest ride height setting, while simultaneously raising the downhill side of the vehicle to its maximum ride height setting. This can be done prior to the vehicle actually encountering the sloped terrain and under the control of the driver using his own senses, or using a vision system that looks at and analyzes the upcoming terrain.

According to one aspect of the present invention, a method and system for adjusting an orientation of a chassis of a vehicle relative to a terrain includes determining a path of travel of the vehicle over the terrain, determining a slope of the terrain over the path of travel, and adjusting a height of one or more adjustable supports of the vehicle on the basis of the path of travel and the slope of the terrain over the path of travel, said adjusting resulting in a more horizontal orientation of the chassis of the vehicle during traverse of the path of travel by the vehicle.

In one embodiment according to the present invention, the adjustable support may be a dynamically adjustable independent support. In another embodiment according to the present invention, the adjustable support may be an adjustable independent wheel suspension. In a further embodiment according to the present invention, determining the path of travel over the terrain may be manual. Determining of the path of travel may be by an occupant of the vehicle who may be a driver of the vehicle.

In another embodiment according to the present invention, determining the slope of the terrain over the path of travel may be manual. Determining the slope of the terrain over the path of travel may be by an occupant of the vehicle who may be a driver of the vehicle.

In a certain embodiment according to the present invention, adjusting the height of at least one adjustable support may be manual on the basis of the path of travel over the terrain and the slope of the terrain over the path of travel. Adjusting the height of at least one adjustable support may be by an occupant of the vehicle who may be a driver of the vehicle. Adjusting the height of at least one adjustable support may be through manual interaction of the occupant with a controller that may include wireless communication between the controller and at least one adjustable support.

In another embodiment according to the present invention, determining a path of travel of the vehicle over the terrain may include observing the terrain by an occupant of the vehicle who may be a driver of the vehicle.

In an additional embodiment according to the present invention, determining the slope of the terrain over the path of travel may include observing the slope of the terrain over the path of travel by an occupant of the vehicle who may be a driver of the vehicle.

In a further additional embodiment according to the present invention, adjusting a height of at least one adjustable support of the vehicle may include increasing a height of at least one down slope adjustable support of the vehicle. In a still additional embodiment according to the present invention, adjusting a height of at least one adjustable support of the vehicle includes decreasing a height of at least one up slope adjustable support of the vehicle.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a schematic illustration of a prior art vehicle having adjustable supports.

FIG. 2A is a schematic diagram of an adjustable support system for a vehicle according to an embodiment of the present invention.

FIG. 2B is a schematic diagram of an adjustable support system for a vehicle according to an embodiment of the present invention, including wireless communication.

FIG. 3 is a flow chart illustrating a method for adjustment of adjustable supports of a vehicle according to an embodiment of the present invention.

FIG. 4 is a schematic illustration of a vehicle negotiating a path along a side of a hill in accordance with an embodiment of the present invention.

FIG. 5A is a schematic illustration of a front view of a vehicle on horizontal terrain where the chassis is horizontal.

FIG. 5B is a schematic illustration of a front view of a vehicle on a non-horizontal path where the chassis is more horizontal than the is the path.

### DETAILED DESCRIPTION OF THE INVENTION

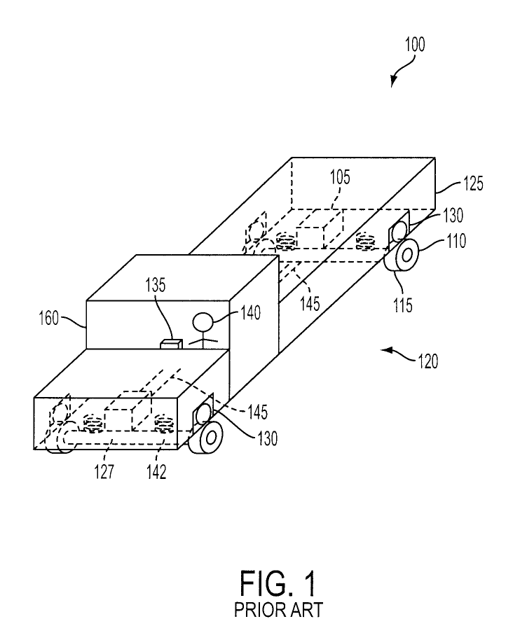

FIG. 1 illustrates a prior art vehicle 100 having a cab 160, a section 127 and a section 125, and which is capable of carrying a load 105. Each wheel 110 of vehicle 100 contacts the ground or terrain 120 with a tire 115. The portion 125 of the vehicle 100 is suspended above each wheel 110 and above the portion 127 by an adjustable wheel support or an adjustable independent wheel suspension 130, illustrated in schematic fashion in FIG. 1 and which may include, but is not limited to, an air spring, an air bag, or a hydraulic strut.

The portion of the vehicle 100 raised by the adjustable supports 130 is the sprung portion 125, and that portion of the vehicle 100 remaining in fixed height relation with the ground or terrain 120 is the portion 127. The portion 127 may include, for example, the wheels 110, including tires 115, and a portion of the suspension components, such as a portion of the adjustable support 130, and the axles 142, and drive train 145, dependent upon the specific vehicle design in use.

There is a driver or occupant 140 as well as a controller 135 which will be described below.

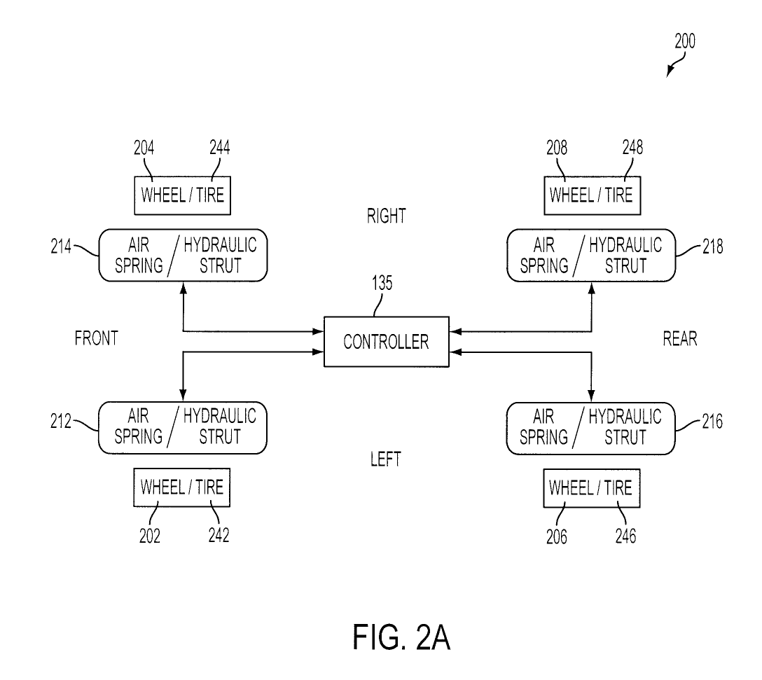

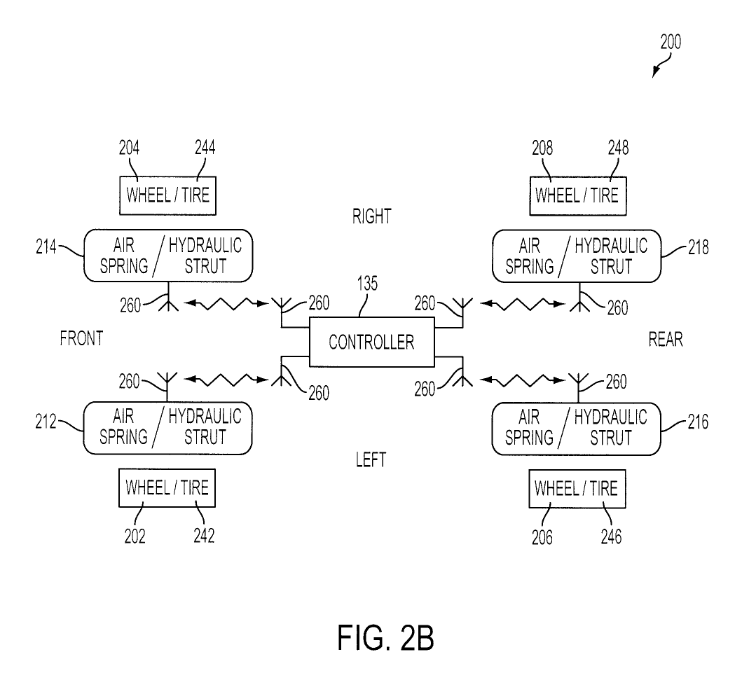

FIG. 2A is a schematic illustration of the components of an adjustable support system 200 according to one embodiment of the present invention (see also FIG. 1). Each wheel 110 (front left 202, front right 204, rear left 206, and rear right 208) is provided with an adjustable support 130 in the form of, but not limited to, an air spring, an air bag, or a hydraulic strut (front left 242, front right 244, rear left 246, and rear right 248) supporting the portion 125 of the vehicle 100 over each wheel 110.

The adjustable supports 242, 244, 246, and 248 provide a variable height support for the portion 125. Selective expansion or contraction of the adjustable supports 242, 244, 246, and 248, for example, inflation or deflation of the air spring 130, permits raising or lowering sections of the section 125 relative to each other and to the ground 120 when the vehicle 100 is traversing over non-horizontal terrain. The adjustable supports 242, 244, 246, and 248 may be adjusted by actions of a driver, an operator, a passenger, or an observer (more generally referred to as an occupant) 140 (FIG. 1) of the vehicle, directly on the adjustable supports 242, 244, 246, and 248 and as a result of the operator 140 interacting with a controller 135 (FIG. 1) to effect adjusting of the adjustable supports. If desired each adjustable support could be adjusted manually.

The controller 135 of the adjustable supports 242, 244, 246, and 248 may be mounted within the cab 160 (FIG. 1 and FIG. 2A) of the vehicle 100 or may be portable and able to be operated from outside of the cab 160 of the vehicle 100. The portable controller 135 may be in wireless communication with the adjustable supports 130, that is, with adjustable supports 242, 244, 246, and 248, as between antennas 260 (FIG. 2B) communicating between the controller 135 and the adjustable supports 242, 244, 246 and 248 in FIG. 2B. The occupant 140 of the vehicle 100 who is usually located within the vehicle 100 may operate the controller 135 manually by providing input directly to the controller 135 to adjust the adjustable supports 242, 244, 246, and 248 by, for example, inflating or deflating the air spring or airbag 130 at any of the wheels 110. Adjustment of the adjustable supports 242, 244, 246, and 248 may be dynamic, thereby allowing adjustment of the adjustable supports as the vehicle 100 moves.

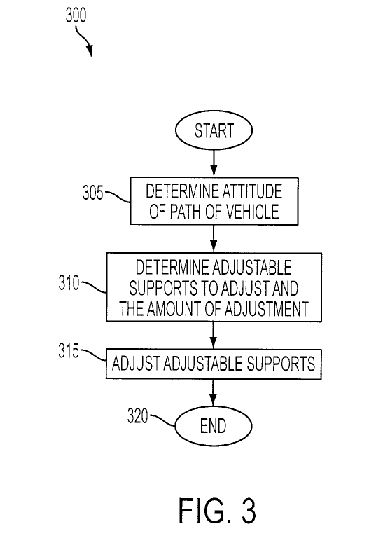

FIG. 3 illustrates a method 300 according to an embodiment of the present invention for the realignment of the attitude or tilt of section 125 relative to that of the ground or terrain 120. According to this method, the start is at step 302, and the first step is to determine the attitude of the path of the vehicle at step 305. The next step at 310 is to determine the amount of adjustment needed to provide the desired change in vehicle attitude (frequently this is the maximum). The next step 315 is to adjust the adjustable supports by the amounts determined in step 310 and the process is stopped in step 320 when the adjustments have been made.

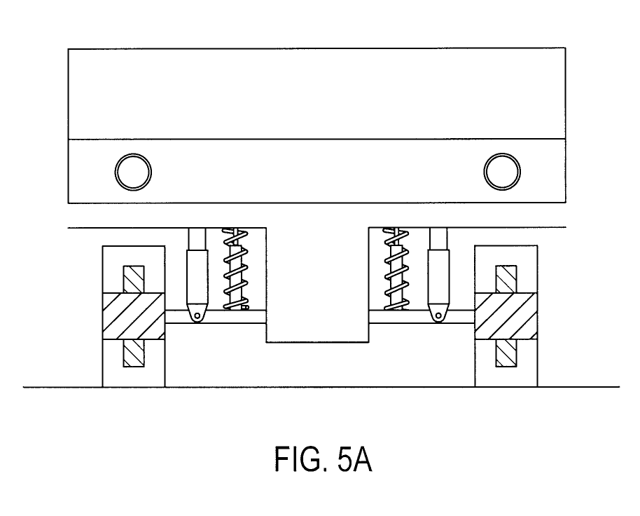

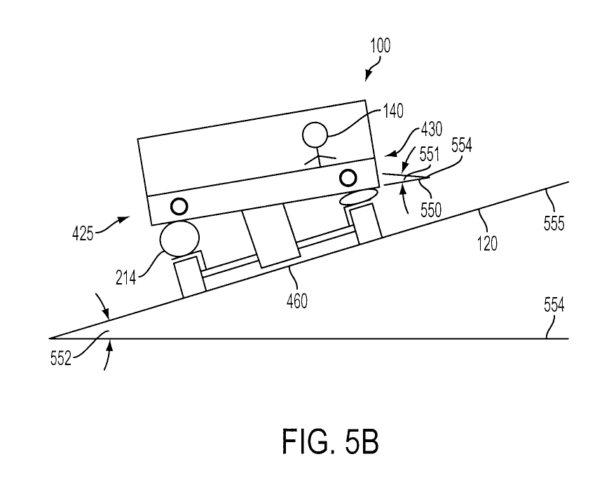

The attitude 551 of the chassis 125 is the angle of the plane 550 of the chassis 125 relative to the horizontal plane 554 and the attitude or slope 552 of the ground or terrain 120 is the angle of the plane 555 of the ground 120 relative to the horizontal plane 554 (FIG. 5B).

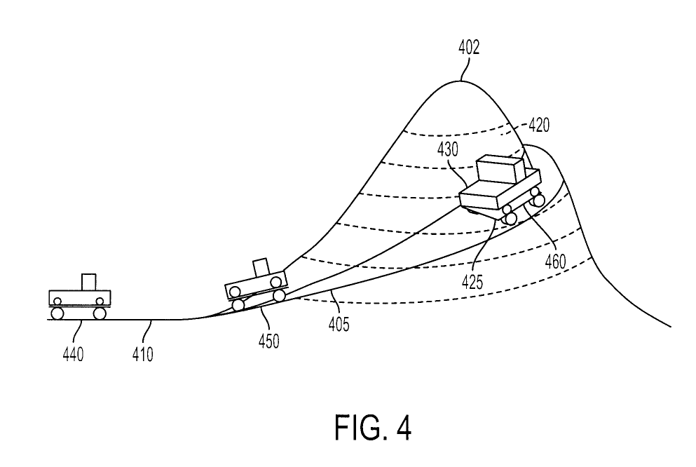

FIG. 4 and FIGS. 5A-5B illustrate application of the method 300 of FIG. 3 to the vehicle 100 traveling on a path 405. The path 405 leading from the bottom 410 of a hill 402 up and along the side 420 of the hill 402 may be done r manually determined by the driver through observation of the surroundings or through interpretation of the surroundings by another occupant 140 of the vehicle 100. In approaching the hill 402, the path of travel 405 of the vehicle 100 extends over horizontal or level ground or terrain 120. The adjustable supports 110 of the vehicle 100 are adjusted to be of equal height and, for example, at minimum level or height. As a result, the attitude 551 of the chassis 125 is substantially zero degrees and the plane 550 of the chassis 125 is substantially parallel to the plane 554 of the level or horizontal ground or terrain 120 (at 440 in FIG. 4 and as shown in FIG. 5A).

The attitude 552 of the ground 120 underneath the path 405 does not remain at zero degrees. Instead, the attitude 552 of the ground 120 underneath the path 405 changes from zero degrees at the base 410 of the hill 402 to an angle corresponding to the slope or attitude 552 of the side 420 of the hill 402 as the path 405 circles about the side 420 of the hill 402. That is, the plane 550 of the chassis 125 with adjustable supports 110 equal in height acquires the attitude 552 of the ground 120 underneath the path 405 path, changing from a horizontal plane 554 to a plane inclined at the angle of the side 420 of the hill 402 relative to the horizontal plane 554

The occupant 140 of the vehicle 100 within the cab 160 through observation determines the path 405 of the vehicle 100, selecting from among alternative routes, and determines the manner in which the slope or attitude 552 of the ground 120 underneath the path 405 changes as the path 405 proceeds about the hill 402 (at 440 in FIG. 4 and at Step 305). The occupant 140 determines that the path 405 climbs upward and that the attitude 552 of the ground 120 increases as the slope of the path 405 conforms to the slope of the hill 402.

To traverse the selected or determined path 405 in a more stable manner, the occupant 140 of the vehicle 100 adjusts the adjustable supports 130. Adjustment of the adjustable supports 130 may be done manually by the occupant 140 of the vehicle 100 or manually through use of the controller 135 from the cab 160 of the vehicle 100.

In the case of the vehicle 100 shown in FIG. 4, the occupant 140 causes the downhill or down slope side 425 (FIG. 5B) of the vehicle 100 to be raised to its maximum height setting by inflating the airbags 110 on the right hand side 425 of the vehicle 110 and causes the uphill or up slope side 430 of the vehicle 100 to be lowered to its minimum height setting by, for example in the situation of FIG. 4, deflating the airbags 110 on the left hand side 430 of the vehicle 100 to the minimum height (at 450 in FIG. 4 and as shown in FIG. 5B). In this manner, the attitude 551 of portion 125 of the vehicle 100 is reduced as the plane 550 of the chassis 125 is made more level with the horizontal plane 552 as the vehicle 100 follows the path 405 around the side 420 of the hill 402 (at 460 in FIG. 4 and as shown in FIG. 5B). Thus, a fully adjustable independent suspension, such as pneumatic, hydraulic, and the like, with significant ride height adjustment capabilities can be provided, so that it is possible to lower the uphill side of a vehicle to its lowest ride height setting, while simultaneously raising the downhill side of the vehicle to its maximum ride height setting based on input from the driver, or a person assisting the driver or a vision system as described in the next paragraph.

The present invention can also be used together with a vision system that looks at and analyzes the upcoming terrain before such terrain is actually reached so that the necessary adjustments for terrain can be made.

The content of pending application Ser. No. 11/850,385 filed Sep. 5, 2007, and its parent application Ser. No. 11/430,771 filed May 9, 2006 are hereby incorporated herein by reference. They disclose some of the structure and method which may be used to increase the ability of the vehicle to increase its side slope operating capabilities for the present invention.

Although the invention has been described with respect to various embodiments, it should be realized that this invention is also capable of a wide variety of further and other embodiments within the spirit and the scope of the appended claims.

1. A method for adjusting the orientation of a vehicle having sections relative to a terrain, the method comprising:
determining the path of travel of the vehicle over the terrain;
determining the slope of the terrain over the path of travel with respect to a horizontal plane; and
adjusting the height of at least one adjustable support of the vehicle based upon the path of travel and the slope of the terrain sufficiently to provide a more horizontal orientation of the section of the vehicle during traverse of the path of travel by the vehicle.

2. The method of claim 1, wherein the adjustable support is a dynamically adjustable support.

3. The method of claim 1, wherein the adjustable support is an adjustable independent wheel suspension.

4. The method of claim 3, wherein said determining the path of travel over the terrain comprises:
determining the path of travel over the terrain manually.

5. The method of claim 4, wherein said determining the path of travel over the terrain manually comprises:
determining the path of travel by an occupant of the vehicle.

6. The method of claim 1, wherein said determining the slope of the terrain over the path of travel comprises:
determining the slope of the terrain over the path of travel manually.

7. The method of claim 1, wherein said adjusting the height of the at least one adjustable support comprises:
adjusting the height of the at least one adjustable support manually on the basis of the path of travel over the terrain and the slope of the terrain over the path of travel.

8. The method of claim 7, wherein said adjusting the height of the at least one adjustable support comprises:
adjusting the height of the at least one adjustable support by an occupant of the vehicle.

9. The method of claim 8, wherein adjusting the height of the at least one adjustable support comprises:
adjusting the height of the at least one adjustable support by an occupant of the vehicle through manual interaction with a controller.

10. The method of claim 9, wherein adjusting the height of the at least one adjustable support comprises:
adjusting the height of the at least one adjustable support by the occupant of the vehicle through wireless communication between the controller and the at least one adjustable support.

11. The method of claim 1, wherein said determining a path of travel of the vehicle over the terrain comprises:
observing the terrain by an occupant of the vehicle.

12. The method of claim 1, wherein said determining the slope of the terrain over the path of travel comprises:
observing the slope of the terrain over the path of travel by an occupant of the vehicle.

13. The method of claim 1, wherein said adjusting a height of at least one adjustable support of the vehicle comprises:
increasing a height of at least one down slope adjustable support of the vehicle.

14. The method of claim 1, wherein said adjusting a height of at least one adjustable support of the vehicle comprises:
decreasing a height of at least one up slope adjustable support of the vehicle.

15. A system for adjusting the orientation of a vehicle having at least four adjustable wheel supports and sections relative to a terrain, comprising:
four adjustable wheel supports; and
means for adjusting the height of said adjustable wheel supports of the vehicle between the sections based upon the path of travel and the slope of the terrain sufficiently to provide a more horizontal orientation of the section of the vehicle during traverse of the path of travel by the vehicle.

16. A system as in claim 15 wherein the adjustable supports on the downhill side of the vehicle are constructed and arranged to be extended when the adjustable supports the uphill side are retracted.

17. A system as in claim 15 wherein the height adjustment is adjusted automatically.

18. A system as in claim 17 wherein the adjusting means include a vision system.
